(19) United States
(12) Patent Application Publication
(10) Pub. No.: US 2025/0310696 A1
(43) Pub. Date: Oct. 2, 2025

(54) VOICE COIL AND SPEAKER DEVICE USING THE SAME

(71) Applicant: GOTO DENSHI CO., LTD., Sagae-shi (JP)

(72) Inventors: Yoshihide GOTO, Sagae-shi (JP); Taiki GOTO, Sagae-shi (JP)

(73) Assignee: GOTO DENSHI CO., LTD., Sagae-shi (JP)

(21) Appl. No.: 19/087,254

(22) Filed: Mar. 21, 2025

(30) Foreign Application Priority Data
Mar. 26, 2024 (JP) 2024-048855

(51) Int. Cl. H04R 9/02; H04R 9/04

(52) U.S. Cl. CPC H04R 9/022; H04R 9/046

(57) ABSTRACT

Provided is a technology that maintains an effect to dissipate heat from a voice coil and achieves higher soundness.

A voice coil 20 includes a bobbin 1 formed approximately cylindrically, and a coil 3 wound around the bobbin 1, and a plurality of protrusions 2 formed on an outer peripheral surface of the bobbin 1. To the outer peripheral surface of the bobbin 1, conductive foil 4 having a projected part and insulating paper 5 having a projected part are attached. The voice coil 20 is used for a speaker device.

### TECHNICAL FIELD

The present invention relates to a voice coil and a speaker device using the same.

### BACKGROUND ART

In general, a speaker device employs a voice coil as a sound source. The voice coil has a structure including an insulated electric wire wound as a coil around a core material referred to as a coil bobbin with the coil (electric wire) having an uninsulated terminal electrically connected to a lead wire such as a tinsel wire. A bobbin serving as the coil bobbin typically has a plurality of slits formed with a predetermined interval in a direction intersecting with a helical direction of the coil (see Patent Literature 1).

In the art in Patent Literature 1, since a voice coil is heated at power ascension of a speaker device, slits are disposed in a bobbin to improve an effect to dissipate heat from a coil. However, there has been a problem in that these slits provide a small contact area between a bobbin and an electric wire, causing less adhesive strength between the bobbin and the electric wire.

### CITATION LIST

### Patent Literature

Patent Literature 1: Japanese Patent Application Laid-Open No. 2002-142292

### SUMMARY OF INVENTION

### Technical Problem

The present invention has an object to provide a technology that maintains an effect to dissipate heat and achieves higher soundness by solving the aforementioned problem.

### Solution to Problem

A voice coil according to an embodiment of the present invention includes a bobbin formed approximately cylindrically, and a coil wound around the bobbin, and a plurality of protrusions formed on an outer peripheral surface of the bobbin.

A speaker device according to an embodiment of the present invention includes the voice coil described above.

### Advantageous Effects of Invention

A coil bobbin in the present invention can maintain an effect to dissipate heat and achieve higher soundness by a plurality of protrusions formed over an outer peripheral surface of the bobbin.

### BRIEF DESCRIPTION OF DRAWINGS

FIG. 1 illustrates a voice coil according to Embodiment 1 in the present invention.

FIG. 2 is a cross sectional view of the voice coil taken along the line A-A shown in FIG. 1.

FIG. 3 is a perspective view of the bobbin in the voice coil in FIG. 1.

FIG. 4 illustrates the voice coil according to Embodiment 2 in the present invention.

FIG. 5 is a developed view of the voice coil shown in FIG. 4.

FIG. 6 is a cross section of conductive foil and insulating paper of a voice coil taken along the line B-B shown in FIG. 5.

### DESCRIPTION OF EMBODIMENTS

Description will now be made of embodiments for implementing the present invention, with reference to the drawings. In description of the drawings, the same reference sign is provided for the same part or a corresponding thereof, and overlapping description is omitted.

The following embodiments are only examples, and these embodiments are not intended to limit the present invention. Furthermore, a voice coil to which the present invention is applied is, e.g., a voice coil for a speaker device, and the following embodiments illustrate application of the present invention to a voice coil for a speaker device.

### Embodiment 1

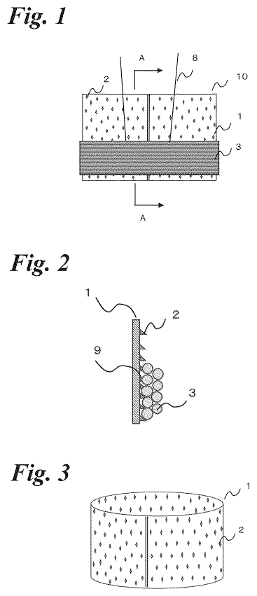

A voice coil 10 in Embodiment 1 will be described with reference to FIGS. 1, 2, and 3. FIG. 1 illustrates a voice coil according to Embodiment 1. The voice coil 10 according to Embodiment 1 includes a bobbin 1, a protrusion 2, a coil 3, an electric wire 8, and a gap 9.

As the front view exemplarily shown in FIG. 1, this voice coil has a structure in which the coil 3 is wound around an outer peripheral surface in a lower part of the bobbin 1, e.g., which has a hollow cylindrical shape. The bobbin 1 includes a plurality of the small protrusions 2. The coil 3 is produced by winding the electric wire 8, e.g., which is insulated by a film. None of the type of the electric wire 8 is particularly limited. As the electric wire 8, enameled copper-clad aluminum wire (CCAW) may be exemplarily employed.

FIG. 2 is a cross sectional view of the voice coil taken along the line A-A shown in FIG. 1. The electric wire 8 is wound around on the protrusion 2 of the bobbin 1, and the coil 3 is formed on the protrusions 2. Spaces of gaps 9 are individually formed between the bobbin 1 and the coil 3 and between the protrusions 2 and coil 3. The protrusions 2 function as spacers that separate the coil 3 from an outer peripheral surface of the bobbin 1.

FIG. 3 is a perspective view of the bobbin shown in FIG. 1. The bobbin 1 is formed approximately cylindrically. On the bobbin 1, a plurality of the protrusions 2 are formed over a whole circumference of the outer peripheral surface. The protrusions 2 are formed so as to project from the outer peripheral surface in a direction from the center of the bobbin 1 to the outer peripheral surface. The protrusions 2 may be formed. e.g., to rise up in punching burr shapes like a grater. This causes the protrusions 2 to have a role in holding a displacement of the electric wire 8 and maintain a position of the electric wire 8 more firmly.

The size of the protrusion 2 is preferably such a size to form the gap 9, a space, between the protrusion 2 and the coil 3 when the coil 3 is wound around the bobbin 1 as shown in FIG. 2. For example, the size of the protrusion 2 on the bobbin 1 is preferably 1 mm or less in length. A material of the bobbin 1 may employ any of metals such as aluminum, polyimide film, glass fiber, meta aramid fiber, and composites thereof. This can provide the bobbin 1 with weight reduction and improved heat resistance. The protrusion 2 on the bobbin 1 may be formed by, e.g., mold processing such as shear processing or injection molding.

Next, an example of a method of producing the voice coil 10 will be described. For example, a plate member is shaped with one side on which a plurality of the protrusions 2 is formed as shown in FIG. 5 described later, by shear processing, injection molding, or the like. Then, the plate member is shaped cylindrically so as to dispose the plurality of the protrusions 2 on the outer peripheral surface, thereby forming the bobbin 1 with an approximately cylindrical shape as shown in FIG. 3.

An adhesive is applied onto a surface of the approximately cylindrical bobbin 1 over which the electric wire 8 is then wound around, thereby forming the coil 3 on the outer peripheral surface of the voice coil 10. By drying the adhesive adhered on the bobbin 1 and the coil 3, the adhesive is cured to form a coil bobbin 10. The aforementioned bobbin 1, which has the plurality of the protrusions 2, is shaped from a plate member, but the approximately cylindrical bobbin 1 may be formed by cast processing, injection molding, and the like from the start.

As shown in FIG. 2, presence of the plurality of small protrusions 2 on the bobbin 1 causes the gap 9, a space, to individually form between the protrusions 2 and the coil 3, and between the bobbin 1 and the coil 3. This improves heat dissipation of the coil bobbin 10, thus providing a voice coil and a speaker with increased heat resistance. Formation of the protrusions 2 on the bobbin 1 into punching burr shapes leads to firmer maintenance of a position of the electric wire 8, thus allowing prevention of slippage, release, or the like between electric wires.

In Embodiment 1, as shown in FIGS. 1 and 2, presence of the protrusions 2 on the bobbin 1 better keeps a contact area between the bobbin 1 and the electric wire 8, compared to presence of slits in the bobbin 1. This causes an adhesive to permeate around the small protrusion 2, thus better increasing adhesive strength.

When slits are provided in a bobbin as with the conventional art, individual designing is required in consideration of a structure of a coil. Moreover, the slits reduce the whole mechanical strength of the bobbin, particularly causes ease of damage around a slit during winding of the coil. This causes difficulty in producing a structure of a slit bobbin. By contrast, uniform presence of the protrusions 2 throughout the bobbin 1 as in Embodiment 1 makes production of a bobbin easier, and also improves durability as no breakage occurs even during production of a voice coil. Accordingly, the structure of the bobbin 1 shown in FIG. 3 can also be used in various coils and has excellent versatility.

### Embodiment 2

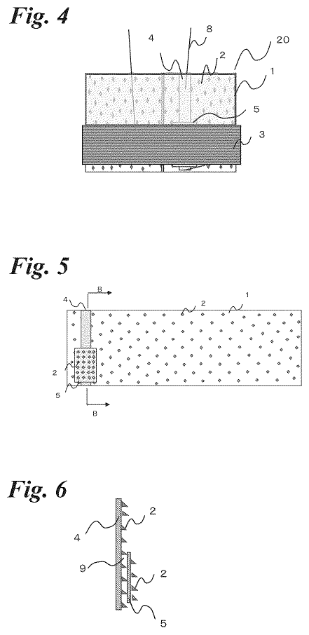

In Embodiment 2 in the present invention, unlike Embodiment 1, a voice coil 20 in which conductive foil 4 and the insulating paper 5 are attached on a bobbin 1 will be described with reference to FIGS. 4, 5, and 6. In Embodiment 2, description of an item similar to that of Embodiment 1 mentioned previously is omitted, and an item different from Embodiment 1 mentioned previously is mainly described.

FIG. 4 illustrates the voice coil according to Embodiment 2 in the present invention. The voice coil 20 according to Embodiment 2 includes the bobbin 1, protrusions 2, a coil 3, the conductive foil 4, the insulating paper 5, an electric wire 8, and a gap 9.

FIG. 5 is a developed view of the voice coil shown in FIG. 4, without the coil 3. FIG. 6 is a cross sectional view of a part including the conductive foil and the insulating paper in the voice coil taken along the line B-B in FIG. 5.

As shown in FIG. 5, on the bobbin 1, the conductive foil 4 is attached, e.g., so as to cover a part of the bobbin 1 vertically extending on the outer peripheral surface of the bobbin 1. As shown in FIGS. 5 and 6, the conductive foil 4 includes a plurality of the protrusions 2 on one side. The plurality of the protrusions 2 on the conductive foil 4 is formed so as to project from a surface of the conductive foil 4. On the conductive foil 4, the insulating paper 5 is attached. The insulating paper 5 includes a plurality of the protrusions 2 on one side. The plurality of the protrusions 2 on the insulating paper 5 is formed so as to project from a surface of the insulating paper 5.

As shown in FIG. 6, presence of the plurality of the small protrusions 2 on the conductive foil 4 also causes formation of the gap 9 as a space between the conductive foil 4 and the insulating paper 5, and further causes, together with the protrusion 2, formation of the gap 9 as a space between the insulating paper 5 and the coil 3. In this case, the plurality of the protrusions 2 on the conductive foil 4 forms a projected part in the conductive foil 4, and the plurality of the protrusions 2 on the insulating paper 5 forms a projected part in the insulating paper 5.

An exemplary method of producing the voice coil 20 will then described. In Embodiment 2, the conductive foil 4 and the insulating paper 5 are attached to the bobbin 1. As shown in FIG. 5, a side of the conductive foil 4 having no protrusion 2 is attached to stack on the bobbin 1 having the plurality of the protrusions 2. Then, a side of the insulating paper 5 having no protrusion 2 is attached to stack on the conductive foil 4 attached on the bobbin 1. This causes the protrusions 2 on any of the bobbin 1, the conductive foil 4, and the insulating paper 5 to be located on a place where the coil 3 is absent, as shown in FIGS. 5 and 6.

As for a bobbin, conductive foil and insulating paper may be used as components of a connection circuit of a lead wire or a tinsel wire. Nevertheless, there has been a problem in that when a coil is wound on such a bobbin, winding of the coil on the bobbin, conductive foil and insulating paper forms a multi-layer, leading to less heat dissipation. By contrast, Embodiment 2 provides the bobbin 1 and the conductive foil 4 with improved heat dissipation, and thus, even in a multi-layer, can solve a problem in that volatilization of a component of an adhesive is likely to generate gas in each layer.

In Embodiment 2, the conductive foil 4 and the insulating paper 5 also have the protrusions 2, thereby retaining a contact area between the insulating paper 5 and the electric wire 8, as shown in FIGS. 5 and 6. This causes an adhesive to permeate around the small protrusion 2, thus better increasing adhesive strength.

Next, action will be described. The speaker device has a configuration e.g., as shown in FIG. 1 in Patent Literature 1. The voice coil 10 as shown in Embodiment 1 described above is used as, e.g., a voice coil for a speaker. When a current flows in the coil 3, an upward or downward driving force corresponding to the direction of the current acts on the voice coil 10. The voice coil 10 is movable, and the driving force acted on the voice coil 10 is transmitted via the bobbin 1 to a diaphragm (not depicted), thereby generating a sound. The same applies to a case where the voice coil 20 shown in Embodiment 2 described above is used as a voice coil for a speaker.

Then, a test of the speaker device with use of the voice coil 20 will be described. To the speaker device, six voice coils 20 as shown in FIG. 4 are attached. The voice coils 20 has a single roll of ribbon cable. To the bobbin 1, the conductive foil 4 is attached for soldering a copper wire on the winding end of the coil 3.

First, description will be made of a reliability test of the voice coil 20 employing the bobbin 1. Conditions of the test are as follows.

### <Test Conditions>

Voltage: 42.8V
Frequency: 50 to 500 Hz
Time: 100 hours
Criteria of failure: release of an electric wire, etc.

In the reliability test, all of the six voice coils 20 were passed. None of the voice coils 20 expanded in a winding width and produced release of an electric wire from the bobbin 1.

Next, an accelerated test was performed. In a conventional voice coil having slits, release of an electric wire from a bobbin occurred at about 330° C. to 340° C. By contrast, in the voice coil 20, release of an electric wire from the bobbin 1 did not occur up to about 390° C. to 400° C., confirming an effect of improved heat resistance.

Furthermore, a type with no use of conductive foil in the coil bobbin 10 as shown in FIG. 1 is also expected to improve heat dissipation, heat resistance, and close contact as with the coil bobbin 20.

Embodiments in coil bobbins in the present invention and speaker devices using thereof have been described so far, but the present invention is not limited to these embodiments, and various modifications can be made within the scope of each of the claims. The embodiments described below including modifications are solely examples, and the technical scope of the present invention is not limited thereto. The technical scope of the present invention also includes various modifications.

The embodiments described above illustrate use of a bobbin in a voice coil. Such a bobbin has improved durability, and the structure of a bobbin 1 may thus be used in various coils other than a voice coil.

The embodiments described above illustrate a case of protrusions provided over a whole circumference of a bobbin 1, but protrusions 2 may be provided only on a part where a coil 3 is wound around the bobbin 1. With regard to conductive foil 4 and insulating paper 5, a protrusion 2 may also be provided on a part where a coil 3 is wound around the conductive foil 4 and the insulating paper 5.

A method of producing a voice coil 10 has no particular limitation in a procedure or a step thereof, and can be modified variously.

### REFERENCE SIGNS LIST

1: coil bobbin
2: protrusion
3: coil
4: conductive foil
5: insulating paper
8: electric wire
9: gap
10, 20: voice coil

1. A voice coil comprising:
a bobbin formed approximately cylindrically,
a coil wound around the bobbin, and
a plurality of protrusions projected from an outer peripheral surface of the bobbin and formed over a whole circumference of the outer peripheral surface.

2. The voice coil according to claim 1,
wherein conductive foil having a projected part is attached to an outer peripheral surface of the bobbin.

3. The voice coil according to claim 2,
wherein the projected part of the conductive foil is formed in such a manner that a plurality of protrusions projects from a surface of an outer peripheral side of the conductive foil.

4. The voice coil according to claim 2,
wherein insulating paper comprising a projected part is attached to the conductive foil.

5. The voice coil according to claim 4,
wherein a projected part of the insulating paper is formed so as to project from a surface of an outer peripheral side of the insulating paper.

6. The voice coil according to claim 1, wherein the protrusion has a length of 1 mm or less.

7. The voice coil according to claim 1,
wherein a material of the bobbin is formed of any of metal, polyimide film, glass fiber, meta-aramid fiber, and composites thereof.

8. A speaker device comprising the voice coil according to claim 1.
